(19) United States
(12) Patent Application Publication
(10) Pub. No.: US 2007/0267239 A1
(43) Pub. Date: Nov. 22, 2007

(54) Device for side impact protection

(75) Inventors: Frank Engels, Drolshagen (DE); Stefan Gunther, Wiehl (DE); Eckhard Hauer, Gummersbach (DE); Hubertus Steffens, Drolshagen (DE)

Correspondence Address: HUDAK, SHUNK & FARINE, CO., L.P.A., 2020 FRONT STREET, SUITE 307, CUYAHOGA FALLS, OH, 44221, US

(73) Assignee: AUTOMOTIVE GROUP ISE INNOMOTIVE SYSTEMS EUROPE GMBH, Bergneustadt (DE)

(21) Appl. No.: 11/804,125

(22) Filed: May 17, 2007

(30) Foreign Application Priority Data
May 19, 2006 (DE) 10 2006 023 922.9

(51) Int. Cl. B60K 28/12; E05C 3/06; B60J 5/00

(52) U.S. Cl. 180/281; 180/274; 296/146.11; 292/201

(57) ABSTRACT

In a device for the side impact protection for a vehicle door of a vehicle, at least one arrangement is provided for moving the vehicle door before and/or during an impact outwards in the direction away from the vehicle interior.

### CROSS REFERENCE

This application claims the benefit of German Patent Application No. 10 2006 023 922.9, filed May 19, 2006.

### FIELD OF THE INVENTION

The invention relates to a device for the side impact protection for a vehicle door of a vehicle and an arrangement for moving a vehicle door outwards in the direction away from the vehicle interior of a vehicle by using such a device.

### BACKGROUND OF THE INVENTION

Precisely with a side impact of a vehicle against an obstacle or in the event of a side impact of another vehicle or object against the doors of a vehicle, the latter are exposed to considerable mechanical loads on account of the, in some cases, not insignificant impact energy. The vehicle doors thereby become deformed or destroyed in such a way that they penetrate into the interior of the vehicle in which the occupants are located and the occupants therein may suffer serious injury even with a minor side impact. It also proves to be a particular disadvantage here that high forces or accelerations occur in the transverse direction of the vehicle, which can also cause serious injuries to the occupants. In the prior art, numerous measures are known which are intended to provide a device for the protection of the occupants in the event of a side impact. One solution consists, for example, in reinforcing an existing door structure with cross-beams, which are intended to reduce the impact energy by deformation. DE 199 35 255 A1, for example, discloses a side impact protection for a vehicle door, wherein profile sections are provided as stiffening elements, which are arranged beside one another in a laminar form and are connected to the vehicle door. The profile sections absorb the impact energy in the event of a side impact and distribute it to the whole vehicle door.

DE 199 05 196 A1 also discloses the provision of a profile element as a side impact protection.

There is also known from DE 197 55 935 A1 a side impact protection for motor vehicle side doors by means of reinforcement elements, wherein a bumper is provided, which is fitted at its two ends to a door outer wall by means of two fastening clips. The side impact protection further comprises an upper reinforcement element, which is welded to the door outer wall in a position above the bumper. Furthermore, U-reinforcement elements are installed at regular intervals from one another in a vertical position in the lower part of the door inner wall and the door outer wall. DE 197 36 100 A1 also discloses a similar side impact protection, wherein arc-shaped bars are fixed to the door frame, which extend over the area of the door. Two such stay bars intersect in a play-free manner, there being provided between two such arc-shaped stay bars a block-shaped pressure element, which is located roughly centrally in the door area. DE 196 33 637 A1 discloses a similar device for the side impact protection of a vehicle door, wherein the likewise curved stay bars form a kind of guard net inside the door structure of the vehicle.

According to DE 196 05 450 A1, there is proposed in turn a side impact protection support with a hollow section, which is fixed to the vehicle door. DE 196 00 932 A1 discloses an arrangement for the side impact protection for a vehicle, which comprises strip- or tube-shaped reinforcement elements, whose ends are fixed to flat mounting supports, whereof the mounting support assigned to the first end of the reinforcement element is connected to a lock support and the mounting support assigned to the second end of the reinforcement element is connected to a hinge support of the motor vehicle door. The mounting supports of the reinforcement elements are fixed by means of punch riveting or by pressure jointing to the lock support and/or the hinge support of the motor vehicle door. DE 195 40 311 A1 also discloses a side impact protection, which also comprises a tubular support and which is fixed to the vehicle door for the reinforcement of the latter. DE 195 19 509 A1 also discloses an impact support as a side impact protection, which is linked to a frame of a vehicle door at the front hinge reinforcement of a front frame part and a rear lock reinforcement of a rear frame part of the frame module of the vehicle door. DE 102 48 846 A1 and DE 102 48 845 A1 also disclose a side impact protection by the provision of a stiffening element in the form of a hollow profile comprising two brackets, wherein its width corresponds to a multiple of its height and wherein this hollow profile extends over a part of the length of a sill of the vehicle and is fixed to the sill.

DE 100 09 675 A1 discloses a side impact protection for a vehicle, wherein a side impact support and a Bowden cable are provided, which runs at an angle to the side impact support. The penetration depth of the door with respect to the vehicle frame is thereby intended to be reduced. A further specially configured side impact protection in the form of a reinforcement support is disclosed by DE 44 42 761 A1.

A further stiffening support is disclosed by DE 44 23 741 A1 and DE 44 23 687 A1. DE 44 13 022 A1 discloses a side impact protection for a vehicle, which is fitted by means of closure pieces in a releasable fashion to the door, whereby the vehicle door can be opened after the release of the closure pieces and whereby the side impact protection transmits forces at right angles to the vehicle direction and forces along the vehicle direction to the bodywork.

DE 43 28 441 A1 also discloses the provision of a profiled part in the vehicle door to create a side impact protection. DE 43 27 393 A1 also discloses a support part for incorporation into a vehicle door as a side impact protection. An outwardly arched profiled support which is integrated into a vehicle door emerges from DE 42 13 817 A1.

EP 0 879 720 A2 discloses a side impact protection in vehicle doors, wherein once again a stiffening profile is arranged in the lower region of the vehicle door in the longitudinal direction of the vehicle. Furthermore, an energy-absorbing foam element is arranged in the vehicle door here. The use of metal foam to produce a side impact protection in vehicle doors is also disclosed in DE 197 21 607 A1, wherein the latter is supposed to have a high energy absorption capacity and to be readily adaptable as an energy-absorbing foam element to the contours of the installation space in the vehicle door. Its rear side facing away from the outer skin of the vehicle door is supposed to be supported on a pressure-stiff structure of the vehicle bodywork. There is known from EP 0 806 324 A2 a side impact protection for a motor vehicle, wherein a support extending in the longitudinal direction of the motor vehicle is provided in the form of a hollow profile and an energy absorption region produced by perforation or punching of the hollow profile is formed between an impact wall on the inside of the vehicle and a rear wall facing the vehicle outside. According to DE 299 05 228 U1, the inner door frame and the door lower edge surface are lengthened into the passenger compartment in order to form a side impact protection.

It is true that a marked deformation of the door is prevented by the provision of braces in the door structure for its reinforcement. However, the occupants of the vehicle are correspondingly exposed to very high forces and accelerations and this proves to be a drawback, so that the occupants can also be seriously injured as a result.

A further measure known in the prior art is to provide additional side impact airbags, which are intended to cushion the contact of the vehicle occupants with the deforming door structure and thus prevent the risk of injury or to keep it within acceptable limits. For example, DE 198 20 567 A1 discloses a side impact protection for motor vehicles with an airbag module fixed at the side in the back of a seat, which airbag module comprises a housing which is stable against lateral forces and which has an exit opening facing forwards for the airbag. DE 196 32 616 A1 discloses a side impact protection device, which comprises an airbag arranged in the side wall beneath the window, said airbag expanding between the head of the occupant and the window area. This does not however provide any side impact protection in the lower door region.

According to DE 100 42 419 A1, a roof lining for an interior compartment of a vehicle is disclosed, wherein a lining part arranged on the roof frame of the vehicle is provided, under which a side impact protection is located. The latter is designed in the form of an airbag, which unfolds over the side window when activated.

DE 44 361 39 C1 in turn discloses the provision of a side airbag, which is integrated at the side into the passenger seat and, when released, emerges from the seat contour and is inflated. It thereby bridges the intermediate space between the seat area and the back of the passenger seat.

There is also known from DE 198 16 668 A1 a side impact protection in the form of external bulges, which at the same time form air inlet openings of coolers disposed on both sides of the vehicle.

Furthermore, it is known in the prior art to design the door structure in such a way that it can lie adjacent to the bodywork of the vehicle, whereby it overhangs the sill or the roof region and the A- or B-pillars of the vehicle and thus limits the penetration depth of the door structure into the passenger compartment.

According to DE 195 14 191 A1, a pyrotechnic propellant is arranged in the end region of longitudinal supports or in the side doors of a vehicle and serves to produce a counter-force in the event of an impact, in order to reduce the effect of the force on the vehicle itself. A cartridge containing the propellant is connected to a support, which is arranged close to the outer skin of the vehicle, whereby a deformation element can also be arranged between the cartridge and the support.

It is also known from EP 1 266 804 A2 to displace the passenger seat inwards into the passenger compartment when a side impact occurs. This is intended to create for the occupants a distance from the vehicle door which becomes deformed in the event of an impact and penetrates into the passenger compartment. Such a displacement of the passenger seat nonetheless leads to the occupants of the vehicle being subjected to high forces and accelerations, since the direction of the displacement of the seat is the same as that of the impact. Absorption of the forces cannot therefore take place for the occupants of the vehicle.

The problem underlying the present invention is to protect the occupants of the vehicle more optimally than with the measures of the prior art in the event of a side impact of the vehicle. In particular, the high force and acceleration effect on the vehicle occupants is to be reduced.

### SUMMARY OF THE INVENTION

The problem is solved for a device according to the preamble of claim 1 wherein at least one arrangement is provided for moving the vehicle door before and/or during an impact outwards in the direction away from the vehicle interior. The problem is solved by an arrangement for moving the vehicle door in the outward direction away from the vehicle occupants of a vehicle wherein said arrangement comprises at least two parts which can be swiveled or rotated with respect to one another or at least one extendable part which can engage with the vehicle door. Additional developments of the invention are defined in the dependent claims.

A device is thus created for the side impact protection for a vehicle door of a vehicle, wherein more space is created for the occupants of the vehicle by the movement of the vehicle door outwards in the direction away from the vehicle interior, i.e. a shifting outwards of the vehicle door before and/or during an impending side impact, which space not only makes it possible to reduce impact energy, but also creates more survival space for the occupants without moving their seats. According to the invention, additional space is created for the occupants in a controlled manner, said space being available for reducing impact energy and thus leading to a situation where the occupants sitting in the vehicle are only subjected to smaller forces and transverse accelerations. Doors shifted outwards by the device according to the invention are struck earlier by the impact than those which in the prior art are arranged in the normal position in the vehicle bodywork and are merely additionally equipped with reinforcements and/or airbags. As a result of the shifting-outwards of the vehicle doors, the impact energy can be absorbed earlier in a targeted fashion and the impact can thus be taken up more smoothly than with the solutions of the prior art. Furthermore, on account of the door or doors being shifted outwards after the side impact, jamming of the latter in the door opening of the vehicle bodywork can be avoided and rescue of the occupants assisted, since the vehicle doors can be opened more readily and more quickly. This is likewise not possible with the solutions of the prior art. On the contrary, DE 43 39 859 C1, for example, provides a four-bar hinge arrangement for vehicle doors which is precisely intended to prevent the doors from jumping open in the event of a side impact.

To advantage, the at least one arrangement for moving the vehicle door is arranged or can be arranged in the region of a door lock between the lock part on the door side and of the lock part on the vehicle bodywork side. In principle, it would also be possible to provide it on the hinge side between a hinge part fixed to the door and a hinge part fixed to the vehicle bodywork. Since the lock part arranged on the vehicle door in any case engages releasably in the lock part on the vehicle bodywork side, however, it is precisely there that there is a particularly good possibility of providing an additional arrangement as a replacement for the one lock part, in particular that on the vehicle bodywork side, in order to enable the shifting-outwards of the door in the event of a side impact. To advantage, therefore, the arrangement is fixed in the region of the lock part on the vehicle bodywork side and designed capable of being engaged in the lock part on the door side. The arrangement can also be retrofitted in used vehicles without problem, since it merely needs to be arranged there on the bodywork side in place of, for example, a lock stirrup and, for this purpose, provided with suitable fixing devices. In addition, or alternatively, it can also be arranged in a housing which is fixed for its part on the bodywork side. The device can for example be integrated into a B- and/or a C-pillar of a vehicle, depending on whether a vehicle front door or a vehicle rear door is intended to be designed capable of being shifted outwards by it.

In order to enable a shifting-outwards of the door, the arrangement is advantageously a multi-part one, wherein the individual parts of the arrangement are designed mobile with respect to one another. As a result, the parts of the arrangement can be swiveled and/or rotated with respect to one another, so that a shifting-outwards of a vehicle door connected to the part rotated outwards or swung outwards is possible. Alternatively, or in addition, the door can also be connected to an extendable part of the arrangement for moving the vehicle door and can be shifted outwards when the latter is extended. Instead of a connection to the door, the extendable part can merely engage with the door in order to shift the latter out of the door opening.

In order to enable a latching, locking or arresting of the vehicle door in the shifted-out position, the device advantageously comprises at least one latching, locking or arresting device. After the shifting-outwards or swinging-outwards of the vehicle door out of the door opening, the latter is to advantage latched, locked or arrested in the shifted-out position in order to avoid an undesired subsequent closing. As a result, it can be ensured that the advantage created by the shifting-outwards in terms of a greater survival space for the occupants for taking up the impact energy is not unintentionally lost again.

The arrangement for moving a vehicle door preferably comprises at least one part connectable or connected to the vehicle bodywork and at least one part fixed on the door side. In order to design at least one part of the arrangement so as to be mobile with respect to at least one other part of the arrangement in a predetermined manner, so that the at least one part can be swiveled and/or rotated and/or extended with respect to the at least one other part, at least one shifting-out mechanism is provided. The latter can be arranged on the vehicle bodywork and/or part of the arrangement for moving a vehicle door.

If the device for side impact protection is arranged in particular in the region of a B- or C-pillar of a vehicle in the region of a door lock, the arrangement for moving the vehicle door advantageously has a lock stirrup, which is designed for interaction with the lock part on the door side and replaces a lock stirrup which is otherwise provided there.

In order to enable releasing of the arrangement for moving the vehicle door when corresponding signals are received before and/or during a side impact, said arrangement has, apart from the at least one shifting-out mechanism, at least one release device for releasing the shifting-out mechanism. The release device preferably engages with an activation element, such as for example a preloaded spring element, of the shifting-out mechanism, in order to release the latter. The release device can engage with the latter for example via a release element, such as a release pin or another mobile or releasable element. To advantage, it also comprises an element for triggering the release element for its clearance or release, such as for example a magnetic switch. When a release signal is received, the release element is released or moved, so that the activation element on the shifting-out mechanism enables a movement of the same.

In order to enable the targeted and reproducible shifting-out movement of the vehicle door, a part of the arrangement engaging with the vehicle door and a part of the arrangement connectable or connected to the vehicle bodywork are advantageously provided with at least one guide device for guiding the movement of the two parts. Here, guide elements on the two parts preferably thereby engage in the guide device of the respective other part. In particular, the part of the arrangement provided with the lock stirrup and the part provided with the release device can each be provided with a connecting-link guide, guide pins engaging in the respective guide connecting links.

It also proves to be advantageous if the part of the arrangement engaging with the vehicle door, in particular the part provided with the lock stirrup, has an essentially linear guide device, in particular guide connecting link, and the part of the arrangement fixed on the bodywork side, in particular the part provided with the release device, has a curved guide device, in particular guide connecting link. In the non-extended position, i.e. the rest or normal position, both parts of the arrangement, i.e. the part engaging with the vehicle door and the part fixed on the vehicle bodywork side, are located one above the other in a space-saving manner. When the arrangement is released, the part engaging with the vehicle door is rotated, swiveled or extended or shifted outwards along the guide device of the other part, preferably along the curved guide connecting link. As a result of the provision of a curved guide device, the part of the arrangement connected to the vehicle door for moving the same can be rotated, swiveled or pushed outwards without problem over or under the other part. On account of the provision of a further guide device, preferably linear guide connecting link, the part engaging with the vehicle door is guided in a restricted fashion into the desired position and the vehicle door is opened in a predetermined guided manner. The movement is preferably released by the release device and driven by the activation element of the shifting-out arrangement, in particular a spring element.

The latching or locking device can be designed for example in the form of a corresponding contour of the curved guide connecting-link path, in particular in its end region. The part of the arrangement engaging with the vehicle door for moving the same is hindered, after entry of the guide element into the latching contour, from further movement back along the guide connecting-link path. This prevents the arrangement from jumping out again from the latching or locking position in an uncontrolled manner. On the contrary, this position remains reliably in place in the event of side impact, so that the vehicle door is not brought back into a closed position in an uncontrolled manner, whereby the additional space advantageously created for the occupants would be lost. The arrangement can be designed for example in such a way that the return of the swiveled or extended part of the arrangement into the initial or normal position is possible only by using a tool specially designed for the purpose.

In order to be able to fix the arrangement for moving a vehicle door to the vehicle bodywork, the latter advantageously has at least one fixing device. In addition, or alternatively, the device can be arranged in a housing, which advantageously offers protection against penetrating moisture and can suitably seal off the device against the latter. Furthermore, it is possible by providing such a housing, which is fixed to the vehicle bodywork at a suitable position, to avoid the B-pillar becoming weakened on account of the installation space requirement for the arrangement, since such a housing makes it possible for it to be joined onto the existing vehicle bodywork in the region of the B-pillar. Since it is not absolutely essential for the arrangement for moving a vehicle door to be installed for example in a B- or C-pillar of a vehicle, but rather it can also be joined on there arranged in a housing, it is not necessary to interfere with the shell structure of the vehicle, so that no design changes are required there, but rather the device for the side impact protection can merely be installed there additionally, and this leads to greater acceptance on the part of the vehicle manufacturers.

The angle of the curved guide device is preferably selected in such a way that, in the side view, essentially no open gap remains between the opened vehicle door and the door opening in the vehicle bodywork when the arrangement is activated, i.e. when the vehicle door is shifted outwards, but on the contrary the vehicle door and door opening continue to overlap. This prevents an open gap from arising when the vehicle door is shifted outwards, through which objects could penetrate into the vehicle interior which could injure the occupants.

As a result of the shifting-outwards of the vehicle door, there is provided, as a result of the created additional space and distance of the vehicle door from the occupants, a space in which side and head airbags, which may additionally be installed, can unfold better.

As a result of the provision of a lock stirrup on the device for the side impact protection or the arrangement for moving a vehicle door, which lock stirrup engages in a corresponding closure eyelet on the vehicle door, so that a connection arises between the vehicle bodywork and the vehicle door in the usual way, this further prevents the vehicle door from opening in an uncontrolled manner, i.e. springing open in an uncontrolled manner, in the event of an impact, so that it continues to participate in the deformation and the reduction of the impact energy in the event of a side impact. As a result of the fact that the lock stirrup is not linked rigidly to the B-pillar of the vehicle, as it otherwise usually is, but can change in its position by means of the extension mechanism with a slide-rotary guide, i.e. is mounted rotatably, swiveling and/or folding, it is involved cinematically in the opening process of the vehicle door. A stable and at the same time mobile arrangement is thus created, which in the normal state enables an opening and closing of the vehicle door in the usual way, but which in the event of a side impact shifts the latter outwards and at the same time holds it, in order that it cannot move in an uncontrolled manner into an unexpected position injuring the occupants, this being a particular advantage over devices of the prior art.

In addition to the arrangement for moving the vehicle door, a deformation element fitted in the vehicle door and/or between the vehicle door and the vehicle bodywork can be provided and arranged in such a way that it can expand between the vehicle bodywork and the vehicle door. The deformation element is preferably designed in the manner of a hollow body and fillable with a gas in the manner of an airbag. Alternatively, however, it can be designed as a fold-out box-shaped deformation element or a pneumatically actuated deformation element. The deformation element can be provided for additional support of the vehicle door in the door cutout and can counteract deformation of the vehicle door or limit the penetration depth of the vehicle door into the vehicle interior and/or limit pulling-in of the door opening into the vehicle interior. Furthermore, the deformation element, with its expansion, can assist the extension mechanism of the device for the side impact protection and thus serve as an activation element for the extension of the one part of the arrangement for moving the vehicle door. In such a case, the release device for releasing the shifting-out mechanism can in particular also be formed by the deformation element if, due to installation space, no space is available for another kind of release mechanism on the vehicle bodywork side, e.g. inside the B-pillar of the vehicle.

The device for the side impact protection can be used as a sole side impact protection or as a further addition to existing protection measures against a side impact, for example in combination with side airbags.

On account of the advantageous possibility of constructing the arrangement for moving the vehicle door in a modular fashion, i.e. in a multi-part fashion, so that for example the replacement of existing elements in the region of a door lock of a vehicle is possible, the device or arrangement for moving the vehicle door can be adapted without problem to the most varied vehicle models, so that cost-effective production is also possible on account of large piece numbers with little variance.

### BRIEF DESCRIPTION OF THE DRAWINGS

For a more detailed explanation of the invention, an example of embodiment of the latter is described below in greater detail with the aid of the drawings, wherein:

In the figures:

FIG. 1 shows a perspective view of a vehicle with a shifted-out vehicle door;

FIG. 2 shows a perspective view of a vehicle with two shifted-out vehicle doors;

FIG. 3 shows a detail view of the vehicle according to FIG. 2 with a removed vehicle rear door and through a vehicle front door shifted out by a device according to the invention for side impact protection;

FIG. 4 shows a perspective first side view of a device according to the invention for moving the vehicle doors in the normal position;

FIG. 5 shows a perspective second side view of the device for moving the vehicle door in the normal position, rotated through 180° compared to FIG. 4;

FIG. 6 shows a perspective view of the device for moving the vehicle door according to FIG. 4 in the shifted-out position;

FIG. 7 shows a detail view of the device for the side impact protection in the positioning on the vehicle door and vehicle bodywork in the region of the door opening, according to FIG. 3;

FIG. 8 shows a more simplified perspective detail view of the device according to FIG. 7, whereby the cover elements of the B-pillar of the vehicle have been removed for the purpose of illustration; and

FIG. 9 shows a schematic diagram in plan view of a part of the vehicle door, the device for the side impact protection and a part of a side wall of the vehicle bodywork.

### DETAILED DESCRIPTION OF THE INVENTION

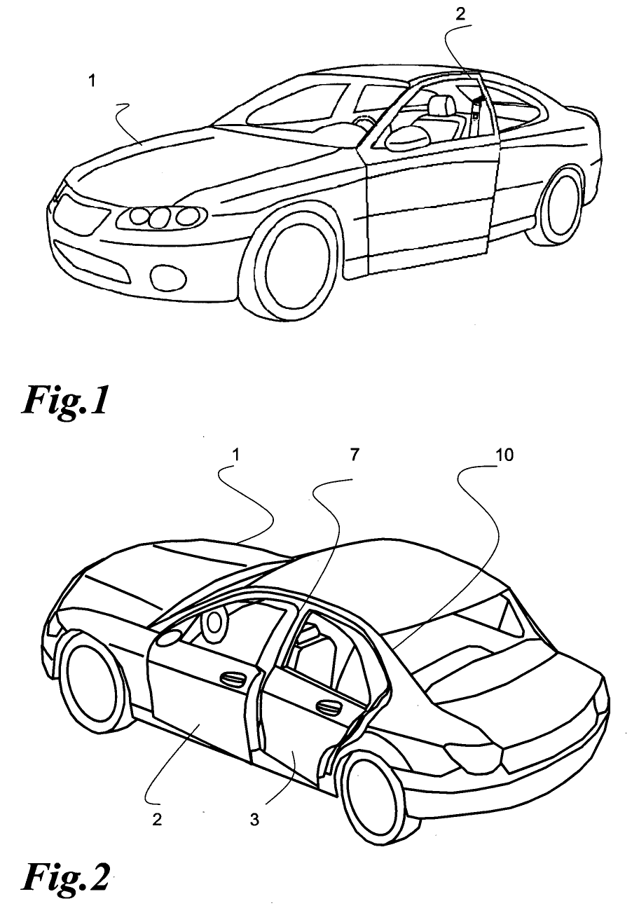

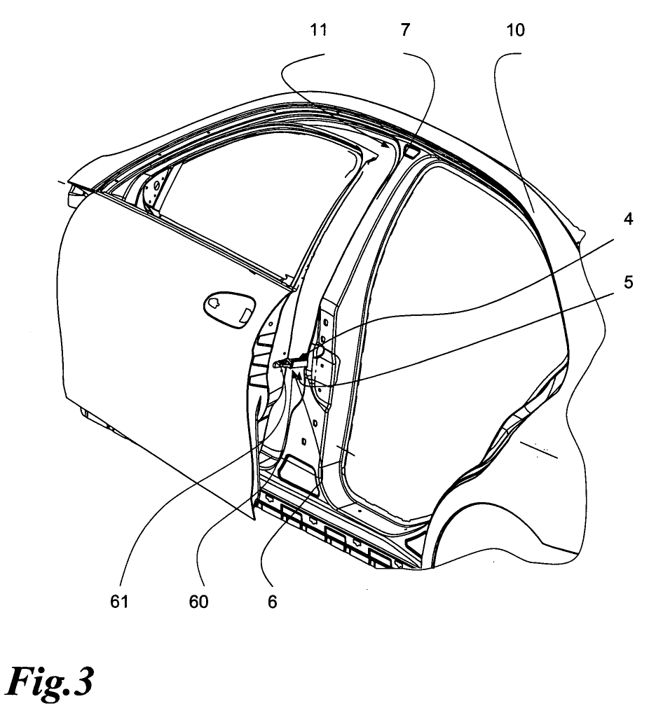

FIG. 1 shows a perspective view of a vehicle 1 with a shifted-out vehicle front door 2. FIG. 2 shows a four-door vehicle 1 with a shifted-out vehicle front door 2 and a likewise shifted-out vehicle rear door 3. The vehicle front door and the vehicle rear door are both shifted outwards in order to absorb a side impact. The shifting-outwards can be released before or during a side impact. For this purpose, sensors are arranged on the vehicle, which detect a side impact situation before and/or during a side impact and send a corresponding signal to a device 4 for the side impact protection. The device can better be seen in FIG. 3, which shows a detail view of vehicle 1 according to FIG. 2.

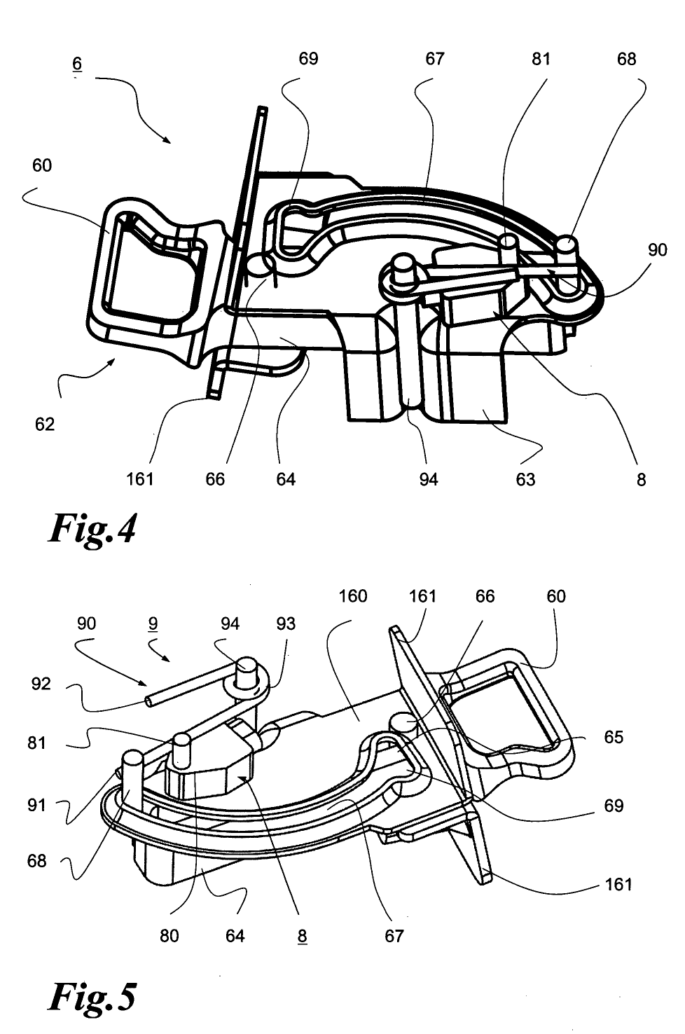

Device 4 for the side impact protection serves to shift outwards the side doors of the vehicle before and/or during a side impact and to hold them in the shifted-out position. For this purpose, it is arranged in the region of door lock 5 of the vehicle. The device comprises at least one arrangement 6 for moving the vehicle door. Only a part thereof is shown in FIG. 3, which part is fixed on the vehicle bodywork side. Said part engages with a lock stirrup 60 in a closure eyelet 61 which is provided on the door side. Such a closure eyelet is usually provided on a door as the lock part provided there, just as a lock stirrup is usually arranged on the vehicle bodywork side in order to engage in the closure eyelet. The distinction from the usual door locks consists solely in the fact that the lock stirrup is arranged on the arrangement for moving the vehicle door, which enables a shifting-outwards of the door. An embodiment of such an arrangement is represented in detail in FIGS. 4 to 6.

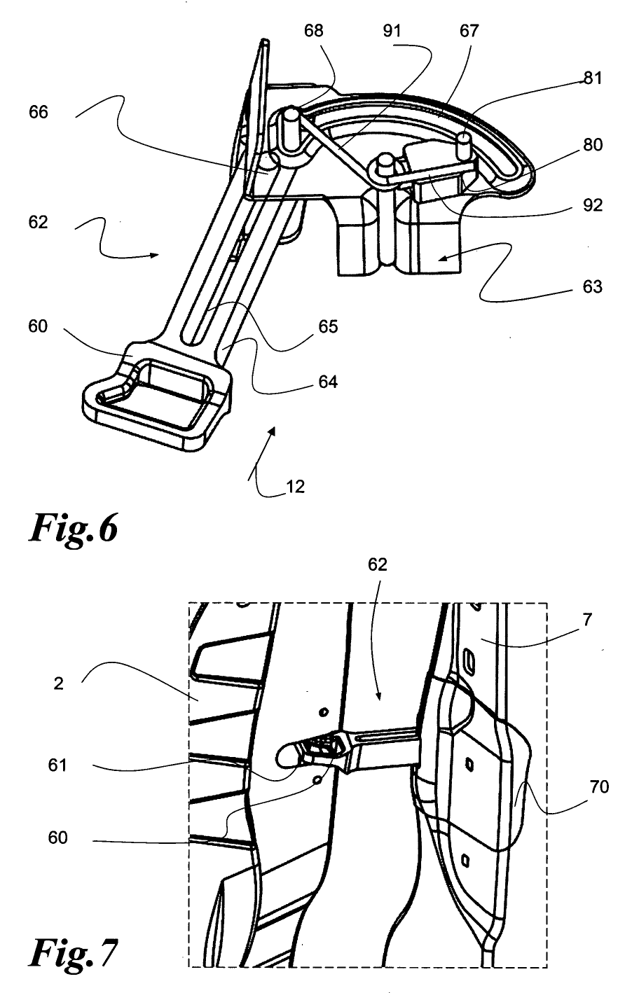

FIG. 4 shows a first perspective side view of the arrangement. The latter comprises two parts mobile with respect to one another, whereby first part 62 is provided with a lock stirrup 60 and a second part 63 is fixed to the vehicle bodywork. Arrangement 6 can either be installed in B-pillar 7 of the vehicle, as shown in FIGS. 1 and 2, or be arranged in a separate housing, which for its part is fixed to the B-pillar or, for the vehicle rear door, the C-pillar. First part 62 of arrangement 6 comprising lock stirrup 60 has an elongated roughly straight section 64, which is provided with a guide connecting-link path 65 provided in its longitudinal direction, as can be seen best from FIG. 6. The guide connecting-link path it designed as a perforation in the embodiment shown, but can for example also be designed as a groove. A guide pin 66 engages in guide connecting-link path 65, said guide pin being fixed to second part 63. Guide pin 66 is also indicated in FIGS. 5 and 6.

Second part 63 of arrangement 6, which is fixed on the vehicle bodywork side, also comprises a connecting-link path 67, in which a connecting-link pin 68 engages, which for its part is fixed to first part 62. Connecting-link path 67 is designed curved as distinct from guide connecting-link path 65 and has at its one end a widened portion 69 as a latching or locking or arresting contour or trough. Guide pin 68, after passing through curved connecting-link path 67, can be arrested or latched in this widened portion of the connecting-link path, whereby in this extended position first part 62 containing the lock stirrup is fully extended, as can be seen in FIG. 6. The procedure for the shifting-outwards of this part 62 of arrangement 6 is dealt with in greater detail in the following.

Second part 63 further comprises a release device 8. In the case shown in FIGS. 4 to 6, this comprises a magnetic switch 80 and a release pin 81. A preloaded leg spring 90 of a shifting-out mechanism 9 engages with the release pin, which shifting-out mechanism, after the releasing of the release device, brings about a shifting-out or swinging-out of first part 62 into the position shown in FIGS. 3 and 6. Leg spring 90 has two legs 91, 92 and a coil portion 93 lying between the latter, which is wound around a spring mounting pin 94, as can be seen in FIGS. 4 to 6. First leg 91 is supported not only on release pin 81, but also on guide pin 68, which rests in curved connecting-link path 67. Second leg 92 is supported on the bodywork side, although this cannot be seen in FIGS. 4 to 6.

Curved connecting-link path 67 in second part 63 of arrangement 6 for moving the vehicle door is arranged in a carrier plate 160 in the example shown in FIGS. 4 to 6. It can be designed as a groove or a perforation, connecting-link path 67 being designed as a perforation in fixing plate 160 in the embodiment shown in FIGS. 4 to 6.

In order to enable the fixing of arrangement 6 for example in a B-pillar or, in the case of use for a vehicle rear door 3, in C-pillar 10 of the vehicle, fixing can take place for example by means of fixing plates 161, which are fixed at an angle from carrier plate 160, as can be seen particularly well in FIGS. 4 to 6. Alternatively, or in addition, the arrangement can be arranged in a housing, which for its part is fixed to the vehicle bodywork.

FIGS. 4 and 5 show arrangement 6 for moving the vehicle door in the normal or rest position, whereas FIG. 6 shows the arrangement in the shifted-out position for the shifting-out of a vehicle door. The curvature of connecting-link path 67 is matched in particular to respective door opening 11 of the vehicle. In the rest state, preloaded leg spring 90 acts via its first leg 91 on guide pin 68. A deflection of the leg spring is avoided by release pin 81 until release device 8 or magnetic switch 80 receives a corresponding release signal, as a result of which the release pin is released and a deflecting movement of the leg spring is enabled. On account of the positioning of guide pin 68 in curved connecting-link path 67, said guide pin is moved by leg 91 of leg spring 90 along connecting-link path 67 and thereby performs a shifting-out or folding-out movement for first part 62 which carries the lock stirrup. The guide pin is moved until it is in widened portion 69 of curved connecting-link path 67 and arrested or latched in this trough-shaped widened portion 69. During the shifting-out or folding movement for the shifting-out of first part 62, which contains lock stirrup 60, with respect to second part 63, first part 62 containing the lock stirrup is guided in a restricted fashion by guide pin 66 along its longitudinally running guide connecting-link path.

As can be seen from FIG. 6, guide pin 68 latches in widened portion 69 or the arresting or latching trough and is not pushed back again along connecting-link path 67 despite the action of a force exerted in the direction of arrow 12, which acts during the side impact on the vehicle door and thus also on first part 62 of arrangement 6. Instead of the trough of the widened portion of curved connecting-link path 67 shown in FIGS. 4 to 6, another kind of latching arrangement can also be provided in order to prevent an undesired movement of guide pin 68 out of this end portion of the connecting-link path. After reaching this end portion of the connecting-link path, a stable unity of arrangement 6 is intended to be provided, which reliably withstands the acting impact force. Uncontrolled jumping-out or sliding-out of guide pin 68 from this portion 69 is thus reliably avoided.

In order to guide first part 62 carrying the lock stirrup back into its initial rest or normal position, the lock stirrup is first released from closure eyelet 61 and is returned back into its initial position by using a suitably provided tool, whereby the spring is returned back into its initial position, as is shown in FIGS. 4 and 5, and is then held again by release pin 81.

Instead of using a leg spring, use may also be made for example of a deformation element which, after actuation of a suitably designed release mechanism, acts on first part 62 carrying lock stirrup 60, in order to move said first part along curved connecting-link path 67. Such a deformation element can be designed for example as a hollow body filled with gas in the form of an airbag, which can expand between the vehicle bodywork and the vehicle door and thereby releases the displacing and rotating guided movement of first part 62 of arrangement 6 for moving the vehicle door.

FIG. 7 shows a detail view of vehicle door 2, B-pillar 7 and arrangement 6 for moving the vehicle door. First part 62, which comprises lock stirrup 60, is hereby extended and the lock stirrup hooks into closing eyelet 61 of door 2. The situation for absorbing a side impact is thus represented. When first part 62 of arrangement 6 is extended, therefore, a defined door gap 13 is created, which depends on the length of section 64 with lock stirrup 60, or more precisely the length thereof projecting from the surface of the B-pillar. By this means, therefore, the space can be determined that is additionally made available for the protection of the vehicle occupants. Furthermore, side and head airbags can also be opened into this space, so that more space is also available here for the vehicle occupants, since said airbags can open not only into the interior, but then also into the door gap.

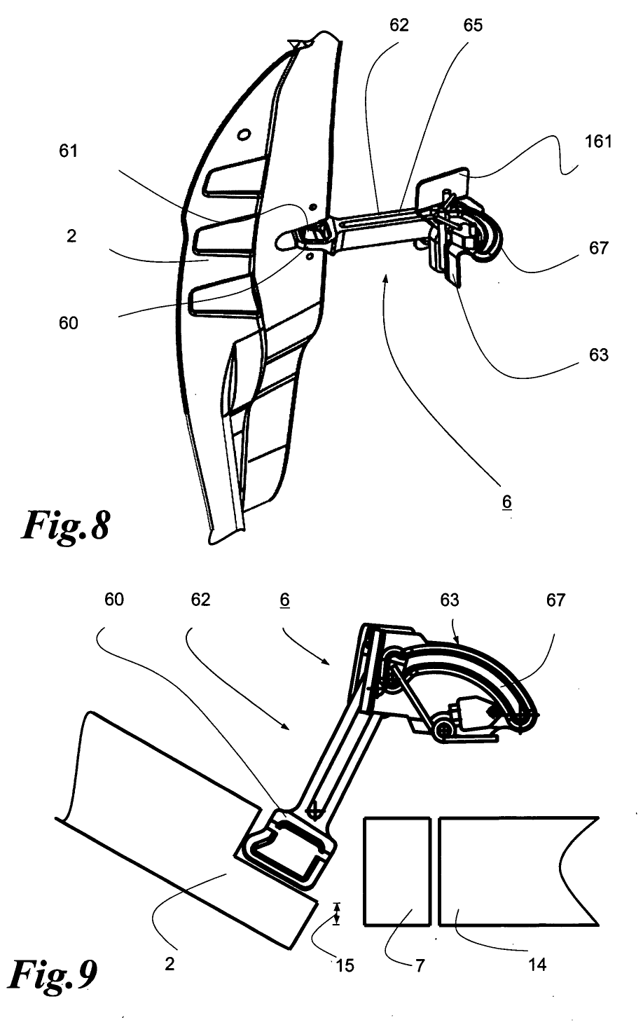

As can be seen from FIG. 7, arrangement 6 is integrated into B-pillar 7, whereby it is covered to the exterior by a closure cover 70, so that second part 63, which can be seen in FIG. 8, is concealed to the exterior behind closure cover 70. In the rest position of arrangement 6, as it is represented in FIGS. 4 and 5, lock stirrup 60 projects out of closure cover 70, as is the case with standard door locks. To that extent, a vehicle provided with the device according to the invention does not differ from a vehicle not provided with the device. If sufficient space for the integration of the arrangement is not available in the B-pillar, an additional housing can be provided which surrounds arrangement 6 and is fixed to the B-pillar. In the case of installation in the B-pillar, such a housing can of course also surround arrangement 6. It proves to be advantageous to provide such a housing, since it can prevent the penetration of moisture when suitable seals are provided, so that protection against corrosion is provided for the arrangement in the interior of the housing.

The schematic diagram of a plan view of the situation of the shifted-out vehicle door represented in FIG. 7 is shown in FIG. 9, whereby it is also ensured, when the length of first part 62 of arrangement 6 is being extended, that an overlap of the door and vehicle side wall 14 is retained, as indicated by gap overlap 15 shown in FIG. 9. Gap overlap 15 serves to prevent the vehicle door from being shifted outwards to such an extent that, in the event of a side impact, objects can enter into the interior of the passenger compartment and injure occupants seated therein. Gap overlap 15 in the given case can be designed specific to the application, i.e. adapted to the given vehicle type and the existing installation circumstances in the region of the vehicle door, the vehicle side walls and also, as the case may be, a B-pillar or C-pillar of the vehicle bodywork.

Apart from the embodiments of devices described above and shown the figures for the side impact protection for a vehicle door of a vehicle, numerous others can also be formed, wherein in each case at least one arrangement is provided for moving the vehicle door before and/or during an impact outwards in the direction away from the vehicle occupants. Apart from the described variant wherein at least one arrangement for moving the vehicle door is arranged in the region of a door lock, such an arrangement can for example be arranged, additionally or alternatively, in a suitably modified design in the region of door hinges. Furthermore, it is possible to provide an arrangement for moving the vehicle door in the region of a door seal, for example in the form of an expandable door seal.

### LIST OF REFERENCE NUMERALS

1 vehicle
2 vehicle front door
3 vehicle rear door
4 device for side impact protection
5 door lock
6 arrangement for moving the vehicle door
7 B-pillar
8 release device
9 shifting-out mechanism
10 C-pillar
11 door opening
12 arrow
13 door gap
14 vehicle side wall
15 gap overlap
60 lock stirrup
61 closure eyelet
62 first part
63 second part
64 section
65 guide connecting-link path
66 guide pin
67 curved connecting-link path
68 guide pin
69 widened portion
70 closure cover
80 magnetic switch
81 release pin
90 leg spring
91 first leg
92 second leg
93 coil portion
94 spring mounting pin
160 carrier plate
161 fixing plate

What is claimed:

1. A device for the side impact protection for a vehicle door of a vehicle, comprising:
at least one arrangement for moving the vehicle door before or during or both before and during an impact outwards in a direction away from an interior of the vehicle.

2. The device according to claim 1, wherein the at least one arrangement for moving the vehicle door is arranged or can be arranged in a region of a door lock between a lock part on the door side and a lock part on a bodywork side of the vehicle.

3. The device according to claim 1, wherein at least one latching or locking device is provided for latching or locking the vehicle door in a shifted-out position.

4. The device according to claim 2, wherein the arrangement is fixed in the region of the lock part on the vehicle bodywork side and can be engaged in the lock part on the door side.

5. The device according to claim 4, wherein the arrangement comprises at least one lock stirrup for cooperating with the lock part on the door side.

6. The device according to claim 1, wherein at least one shifting-out mechanism is provided for swiveling, rotating or extending of at least one part of the arrangement with respect to at least one another part for the purpose of shifting-out the vehicle door.

7. The device according to claim 6, wherein the arrangement comprises at least one release device for releasing the shifting-out mechanism.

8. The device according to claim 6, wherein the shifting-out mechanism comprises at least one activation element, with the actuation whereof at least one part of the arrangement for moving a vehicle door is shifted outwards.

9. The device according to claim 7, wherein the release device is arranged in such a way that it engages with an activation element, with the actuation whereof at least one part of the arrangement for moving a vehicle door is shifted outwards.

10. The device according to claim 8, wherein the activation element is a preloaded spring element, with which at least one release element of the release device engages.

11. The device according to claim 1, wherein a part of the arrangement engaging with the vehicle door and a part of the arrangement connectable or connected to vehicle bodywork are provided with at least one guide device for guiding the movement of the two parts with respect to one another.

12. The device according to claim 11, wherein the guide device is a connecting-link guide.

13. The device according to claim 11, wherein the guide elements on the two parts of the arrangement for moving a vehicle door engage in the at least one guide device of the respective other part.

14. The device according to claim 11, wherein the one part of the arrangement engaging with the vehicle door has an essentially linear guide device and the part of the arrangement fixed on the bodywork side has a curved guide device.

15. The device according to claim 14, wherein the part of the arrangement engaging with the vehicle door is the part of the arrangement provided with the lock stirrup and the part fixed on the bodywork side is the part provided with the release device.

16. The device according to claim 14, wherein the essentially linear guide device or the curved guide device or a combination thereof is a guide connecting link.

17. The device according to claim 7, wherein the part of the arrangement containing the release device comprises at least one element engaging in the connecting-link guide of the part of the arrangement containing the lock stirrup.

18. The device according to claim 3, wherein the latching or locking device is designed in the form of a corresponding contour of a curved guide connecting-link path.

19. The device according to claim 18, wherein the latching or locking device is provided in the end portion of the guide connecting-link path.

20. The device according to claim 1, wherein the arrangement for moving a vehicle door comprises at least one fixing device for the fixing to bodywork of the vehicle.

21. The device according to claim 1, wherein the arrangement for moving a vehicle door is arranged in at least one housing.

22. The device according to claim 1, wherein at least one deformation element is arranged in the vehicle door or between the vehicle door and the vehicle bodywork or a combination thereof.

23. The device according to claim 22, wherein the deformation element is provided as an activation element for extending the one part of the arrangement for moving the vehicle door.

24. An arrangement for moving a vehicle door outwards in the direction away from a vehicle interior of a vehicle, in particular for use with a device according to claim 1, wherein the arrangement comprises at least two parts which can be swiveled or rotated with respect to one another and at least one extendable part which can engage with the vehicle door.

25. The arrangement according to claim 24, wherein the arrangement comprises at least one part provided with a lock stirrup and one part which can be fixed on the door side.

26. The arrangement according to claim 24, wherein the arrangement comprises at least one curved guide connecting link in the one part and at least one linear guide connecting link in the other part.

27. The arrangement according to claim 24, wherein the arrangement comprises at least one release device for releasing a swiveling or rotation of the at least two parts or for extending the one part.

28. The arrangement according to claim 24, wherein the arrangement comprises at least one shifting-out mechanism for the shifting-out of the one part which can engage with a vehicle door.
